(19) United States
(12) Patent Application Publication
(10) Pub. No.: US 2017/0110901 A1
(43) Pub. Date: Apr. 20, 2017

(54) BATTERY PROFILE TRANSLATOR AND REMOTE CHARGING SYSTEM AND METHOD

(71) Applicant: Droneventory Corporation, San Diego, CA (US)

(72) Inventors: Melanie Amarasekara, San Diego, CA (US); Marc Allen Bernard, San Diego, CA (US)

(21) Appl. No.: 15/294,459

(22) Filed: Oct. 14, 2016

Related U.S. Application Data
(60) Provisional application No. 62/242,830, filed on Oct. 16, 2015.

(51) Int. Cl. H02J 7/02; B64C 39/02; H02J 50/90

(52) U.S. Cl. CPC H02J 7/025; H02J 7/027; H02J 50/90; B64C 39/024; H02J 2007/0001

(57) ABSTRACT

The disclosure is related to a system and method for autonomously charging a rechargeable power supply of an Unmanned Aerial System (UAS). The system can have battery power translator (BPT). communicatively coupled to the UAS. The BPT can have an energy source operable to deliver power at a native power level different than a designed power level of the UAS. The BPT can also have a voltage/current translator (VCT) operable to receive energy at the native power level from the energy source, and convert the energy at the native power level to converted energy at the designed power level for use by the UAS. The system can also have a remote charging system (RCS) communicatively coupled to the BPT. The RCS can also have a charging pad having a plurality of configurable terminals, and operable to receive the UAS and deliver recharge energy to the UAS.

### CROSS-REFERENCE TO RELATED APPLICATION

The present application claims the benefit of U.S. Provisional Patent Application No. 62/242,830 filed Oct. 16, 2015 under 35 U.S.C. 119. This prior application is incorporated by reference herein.

### TECHNICAL FIELD

The disclosure is broadly concerned with providing power from an energy storage system to devices requiring a specific power supply that may not match the energy storage system, and recharging the energy storage system while integrated with the device requiring it. In particular, the invention is contemplated to be used to provide DC power to Unmanned Aerial Systems (UAS) using a power storage system other than the storage system that the UAS device was designed to use. The flexibility afforded by the invention can allow the supported devices, UAS in particular, to be employed in applications where the intended power system is unsuitable due to safety concerns, durability issues, duty cycle shortcomings, etc.

### BACKGROUND

Some DC power systems in mobile or portable devices focus on technologies that offer high energy density, re-usability, an absence of the “memory effect”, light weight, and physical design flexibility. Re-chargeable battery technology has evolved to meet these requirements. Some systems employ Lithium-Polymer (LiPo) technology as a means to meet such requirements. LiPo technology has evolved over time to better meet these requirements and has proven superior to other battery chemistries such as Nickel-Cadmium and Nickel-Metal-Hydride. LiPo has a number of shortcomings, however. These include fire and explosion hazard, long charge times, limited lifespan, health hazards and ecologically sensitive disposal processes. The growing popularity of UAS as well as other portable devices requiring DC power can drive continuous improvement in battery technology as well as other technologies including fuel cell, solar and capacitive. The disclosure describes a system intended to allow UAS and other portable devices to take advantage of alternate and emerging technologies for DC power storage that may not match the electrical characteristics or requirements of the LiPo batteries and other energy storage systems for which they were designed.

### SUMMARY

The disclosure provides a device for replacing a rechargeable power supply of an unmanned aerial system (UAS). The rechargeable power supply can have a designed power level required for powering the UAS and for recharging. The device can have a source interface operable to receive power at a native power level from a power source, the native power level being different from the designed power level. The device can also have a transceiver operable to receive a configuration profile indicating charging cycle information. The device can also have one or more processors coupled to the transceiver and the power source. The one or more processors can convert the native power level to converted power at the designed power level based on the configuration profile. The device can also have a device interface coupled to the one or more processors and operable to deliver the converted power to the UAS.

The disclosure also provides a remote charging system (RCS) for recharging a power supply of a UAS having a charging port. The RCS can have a charging pad having a plurality of configurable terminals operable to receive the UAS and transfer power to the UAS. The RCS can also have a transceiver operable to receive information indicating an identification of the UAS. The RCS can also have one or more processors coupled to the charging pad and the transceiver. The one or more processors can sense a charging port configuration of the charging port. The one or more processors can also configure the configurable terminals based on the charging port configuration.

The disclosure also provides a method for charging a rechargeable power supply of a UAS. The UAS can have a designed power level for operation. The rechargeable power supply can have an energy source having a native power level different from the designed power level. The method can include receiving a configuration profile, the configuration profile indicating charging cycle information of the energy source. The method can also include storing the configuration profile to a memory. The method can also include converting, by one or more processors, power from the energy source at the native power level to converted power at the designed power level based on the configuration profile. The method can also include delivering the converted power to the UAS.

The disclosure also provides a system for autonomously charging a rechargeable power supply of a UAS. The UAS can have a charging port with a charging port configuration. The UAS can have a designed power level for operations. The system can have a battery power translator (BPT). The BPT can have a BPT controller communicatively coupled to the UAS. The BPT can also have an energy source operable to deliver power at a native power level different than the designed power level. The BPT can also have a voltage/current translator (VCT) operable to receive energy at the native power level from the energy source, and convert the energy at the native power level to converted energy at the designed power level for use by the UAS. The system can also have a remote charging system (RCS). The RCS can have a RCS controller communicatively coupled to the BPT controller. The RCS can also have a charging pad coupled to the RCS controller, the charging pad having a plurality of configurable terminals, and operable to receive the UAS and deliver recharge energy to the UAS.

Other characteristics and advantages of the disclosure will be realized with a review of the following description and accompanying drawings.

### BRIEF DESCRIPTION OF THE DRAWINGS

The following is a brief description of the accompanying drawings, wherein like numbers refer to like features and characteristics throughout the following Detailed Description, and wherein:

FIG. 1 is a graphical depiction of a system for autonomously recharging unmanned aerial systems;

FIG. 2 is a functional block diagram of an embodiment of a battery profile translator of FIG. 1;

FIG. 3 is a functional block diagram of another embodiment of the battery profile translator of FIG. 1;

FIG. 4 is a functional block diagram of another embodiment of battery profile translator of FIG. 1;

FIG. 5 is a functional block diagram of an embodiment of a remote charging system of FIG. 1; and

FIG. 6 is a functional block diagram illustrating an example wired or wireless processor enabled device that may be used in connection with various embodiments described herein.

### DETAILED DESCRIPTION

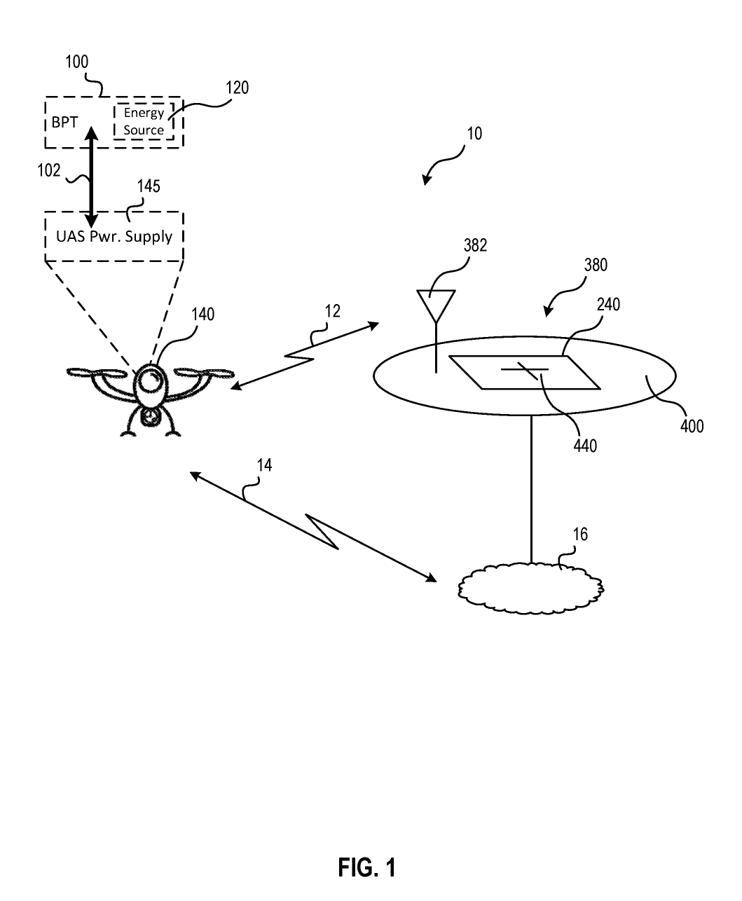

FIG. 1 is a graphical depiction of power support system for autonomously recharging an unmanned aerial system (UAS). Reference to FIG. 1 is made throughout the following descriptions in connection with the other figures.

A power support system 10 can have an UAS (“device”) 140. The device 140 can be one of a variety of UASs or drones, such as, for example, a quadcopter or octocopter operable for remote or autonomous operation. The device 140 can also be other types of autonomous or semi-autonomous systems or robots, for example. In some examples, the device 140 can have a power supply 145. The power supply 145 can have a specific size and specific or designed power specification particular to the electronics of the device 140. In general, the power supply 145 can have a specific power output based on the design requirements of the circuitry within the device 140. Some such requirements may include specific DC voltage, current, temperature, or power requirements necessitating a particular physical, electrical, or electronic configuration and size of a given charging system.

The power supply 145 can be replaced with a battery power translator (BPT) 100. The replacement of the power supply 145 is indicated with a broad arrow 102. The BPT 100 can use an energy source 120 to power the device 140. In some embodiments, the energy source 120 may be any arbitrary energy source. The energy source 120 not may not be a power supply designed for the device 140. In some other embodiments, the energy source 120 may not even be compatible with the device 140 without the use of the BPT 100. The energy source 120 can be a DC power source such as a battery having a native power level different than the designed power level of the device 140. Thus, the BPT 100 can translate (e.g., transform) power at a native power level from the energy source 120, to provide power the device 140 at the designed power level. The BPT 100 can be designed and/or mechanically packaged in various form factors compatible with the form factor and electrical interface of the power supply 145 that it is replacing.

The system 10 can further have at least one remote charging system (“RCS”) 380. Each RCS 380 can provide autonomous communications, homing or navigation services, and charging capabilities to a variety of devices 140 having different or unique charging interfaces or requirements. The RCS 380 can have a charging pad 400 with a device interface 240 and a polarity sensor 440. The charging pad 400 can receive the device 140 and provide power to the BPT 100 during charging or recharging operations. The polarity sensor 440 can facilitate adjustments in charging pad configurations and operations via the device interface 240 according information about the device 140.

The RCS 380 can further have an antenna 382 for communications via a wireless connection 12 with the device 140 (and/or e.g., the BPT 100). The RCS 380 can also communicate with the device 140 and the BPT 100 via a secondary connection 14 and another network 16, such as for example, a local area network (LAN), wide area network (WAN), the Internet, or one or more other data or communications systems or networks. Specific details about particular charging configurations or requirements, availability information, location, or other profile characteristics can be communicated via the wireless connection 12 or the secondary connection 14 between the device 140, the RCS 380, and the network 16. Certain diagnostic data and/or charging cycle information can also be exchanged via the wireless connection 12 or the secondary connection 14. For example, current charge state (e.g., a percent usable power remaining) and flight time remaining to can be communicated between the device 140/BPT 100 and the RCS 380 to aid in scheduling recharge sessions. Once charging has commenced, the wireless connection 12 can be also used by the BPT 100 to provide temperature and voltage information to the RCS 380 to manage charging operations. In some embodiments, data, such as the charge state of each cell in a multi-cell battery (e.g., the energy source 120), can be exchanged between the BPT 100 and RCS 380 to support battery balancing,

In some embodiments, the wireless connection 12 can further provide, for example, a means for preliminary homing (e.g., coarse navigation via radio signaling), or terminal homing (e.g., fine navigation via infrared transmissions) for positioning and landing at the RCS 380. The BPT 100 and the device 140 can then interface with the RCS 380 to receive power to charge the energy source 120 according to the native power requirements. The RCS 380 is described in more detail below in connection with FIG. 5.

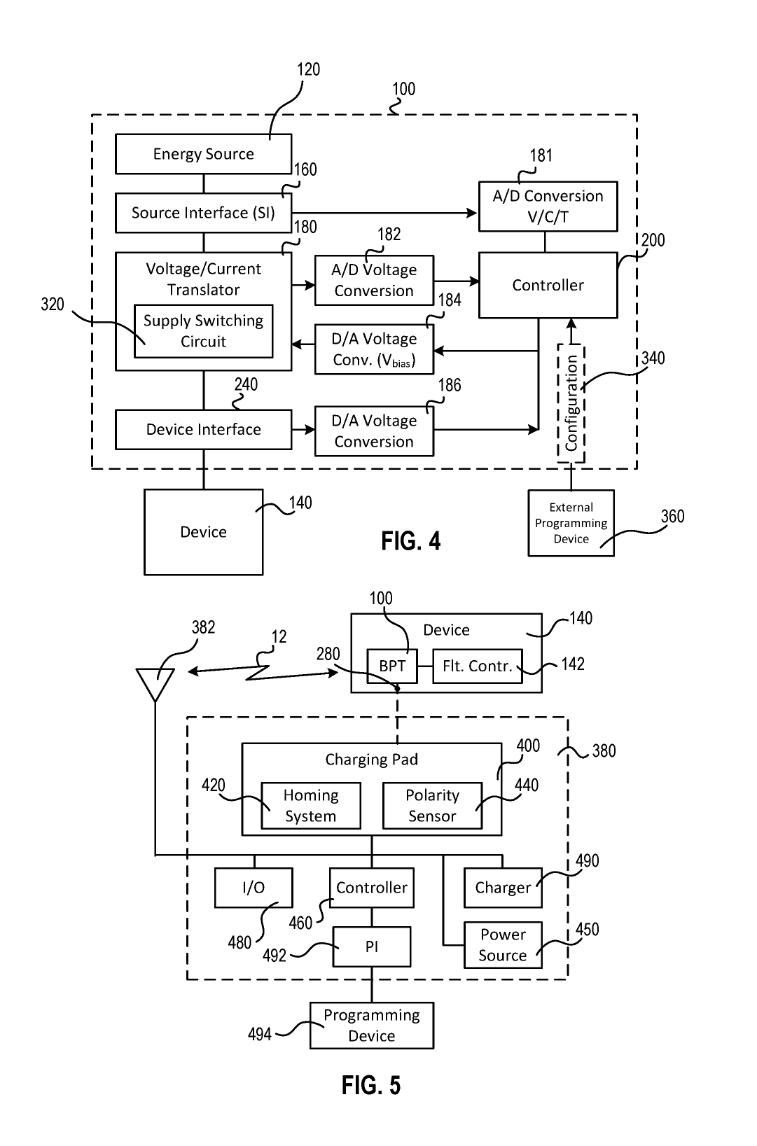

In some embodiments, the device 140 can have a configuration profile (“configuration”) 340 (FIG. 4) indicating the parameters required for charging the power supply of the device 140. The configuration 340 can define one or more behaviors of the BPT 100. The configuration 340 can further contain information about the energy source 120. The configuration 340 can be provided to the BPT 100, for example, concurrently with installation of the energy source 120. The configuration 340 can be set via external means, such as a programming port, for example (see below). The configuration 340 can include, for example, at least a maximum voltage requirement, a minimum voltage requirement, a maximum current, and a temperature range related to the operation of the energy source 120 in conjunction with the BPT 100 and the device 140.

The configuration 340 can be further sent by the device 140 (or the BPT 100) via, for example, the wireless connection 12 or the secondary connection 14. The configuration 340 can provide other information about the device 140, such as, for example, position of the device 140, an indication of an operating system of the device 140, system code language, voltage/current/power required for charging, an indication of the type of physical contacts or charging interface (e.g., electrodes or inductive charging), and several other factors.

The RCS 380 can communicate with BPT 100 via the wireless connection 12 or the secondary connection 14. The BPT 100 can provide information about the specific power requirements of the energy source 120 in order to provide correct parameters for charging when coupled with the RCS 380. The BPT 100 and the RCS 380 are described in further detail below.

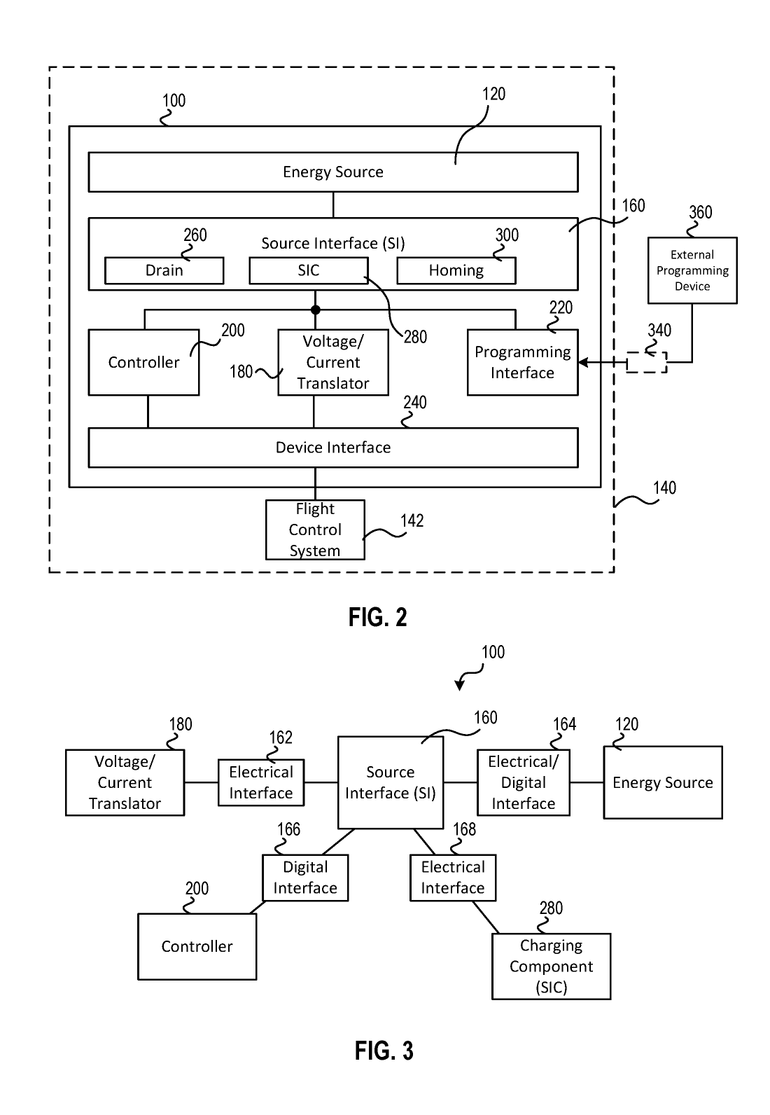

FIG. 2 is a functional block diagram of an embodiment of the BPT 100. The BPT 100 can reside within the device 140, and couple to various components therein. The BPT 100 can use power from the arbitrary energy source 120 to emulate the power supply 145 to provide power to the device 140 at the designed power level. In some embodiments, the device 140 can be designed with a requirement for a specific power level or type of power source. The power level or type of power required by the device 140 may be referred to herein as the “designed power level.”

The BPT 100 can house the energy source 120. The energy source 120 can be an arbitrary direct current (DC) electricity provider with an electrical and supporting interface appropriate to the energy source 120. For example, but not by way of limitation, an automotive or marine class battery (e.g., lead acid) may provide an electrical interface consisting of a cathode and anode while a lithium-polymer battery can augment the same electrical positive/negative interface with, for example, a logical interface to provide temperature or other data. In some embodiments, various types and configurations of “super” capacitors can also be used as the DC energy source 120. Virtually any style of power storage system can be used for the energy source 120.

The BPT 100 can have a controller 200. The controller 200 can direct or command various functions of the BPT 100 and have overall control over the performance of various tasks, such as powering the device 140 at the designed power level. The controller 200 can receive and store the configuration 340 (via the programming interface 220) that defines or governs the behavior of the BPT 100 based on the characteristics of the energy source 120. Using the information provided in the configuration 340, the controller 200 can control the SI 160, the VCT 180, and device interface 240.

The controller 200 can have structures defining the behavior of each of the active components of the BPT 100. As used herein a structure can refer to a programmatic object containing one or more data elements. A structure meant to represent an address may contain street, city, state, and zip data elements, for example. These structures can be communicated using XML.

The controller 200 can further perform operations for recharging the energy source 120 as required, among other operations. The controller 200 can have one or more processors or a central processing unit (CPU). In some embodiments, the controller 200 can be an advanced reduced instruction set (RISC) machine (ARM)—class processor, having flash memory, and digital and analog input-output capability. The digital output can include hardware support for various wireless protocols, such as for example, WiFi, Bluetooth LE, or similar protocols. In some embodiments, certain cellular technologies can also be implemented. In some embodiments, the controller 200 can interface with the control systems within the device 140, such as, for example, a flight control system 142. The flight control system 142 can include one or more systems of subsystems that perform to control the overall flight operations of the device 140 (e.g., the UAS). The flight control system 142 and the controller 200 can exchange data and information regarding the state of the energy source 120, for example, in addition to other information exchanged between the BPT 100 and the RCS 380.

The BPT 100 can also have a source interface (SI) 160 coupled to the energy source 120 and the controller 200. The SI 160 can provide an electrical interface to the energy source 120. In an embodiment, the SI 160 can accommodate a variety of energy sources 120 including, for example, Lithium-Ion, Lithium-Polymer, NiMh, Ni-Cad, Lead Acid, and “Super” capacitor power sources. The SI 160 can provide logical and/or electrical interfaces to support both consumption of power (e.g., by the device 140) from the energy source 120 as well as an interface to the BPT 100 for supplying recharging power to the energy source 120. The controller 200 can control the SI 160 and manage the mode switching between consumption and re-charge modes. The SI 160 can implement a novel re-charging methodology, allowing it to recharge the energy source 120. When used in conjunction with the RCS 380 (described below with respect to FIG. 5), the BPT 100 can support fully autonomous charging of the energy source 120.

The SI 160 can include a SI drain 260 that allows the BPT 100 and its connected device 140 to consume DC power from the energy source 120. In some embodiments, DC power can be passed to the voltage/current translator 180 via the SI drain 260. In concert with the controller 200, the SI 160 can prevent out-of-limit and reverse polarity conditions from occurring on the energy source 120.

The SI 160 can have a charging component (“SIC”) 280. The SIC 280 can have, for example, electronics to support safe charging of the energy source 120. The SIC 280 can accept input from various power sources such as the RCS 380. The SIC 280 can further have terminals (e.g., physical terminals) to interface, for example, with the charging pad 400 of the RCS 380. The terminals can be, for example, positive and/or negative DC outputs and positive and/or negative DC inputs. The terminals can further be multi-strand smart connectors operable to transfer data and power for charging/recharging operations. The terminals can be located externally on, for example, the BPT 100 (and the device 140) and arranged so as to be accessible to the RCS 380.

The SI 160 can also have a homing system 300 to provide navigation and guidance information to the device 140, indicating an absolute or relative position of a nearby RCS 380. The flight control system 142 can receive communications from the homing system 300 for navigation and homing to a desired or programmed destination. The SIC 280 can further leverage the homing system 300 to ensure proper location and alignment of the charging terminals of the BPT 100 (e.g., the SIC 280) with the RCS 380. The controller 200 can communicate with the, for example, the RCS 380 via SI 160 over the wireless connection 12 (e.g., Bluetooth LE or similar).

In some embodiments, the homing system 300 can support the infrared (IR) navigation system used for terminal homing. In some embodiments, the RCS 380 can have an IR transmitter array (described below) that presents a pattern of IR that the homing system 300 can track. The homing system 300 can then provide guidance information or steering commands to the flight control system 142 based on the received IR energy/transmissions. Such commands or other information can be provided via wireless or wired interfaces described herein. The BPT 100 (or more particularly the homing system 300) can also communicate information to an operator to provide capabilities similar to a “flight director.” This can provide direction to a user and allow manual, remote, or semi-autonomous control of the device 140. In some embodiments, the BPT 100 can support an indoor geographic location system. Such a location system can emulate a Global Positioning System (GPS) receiver and replace, for example, a GPS receiver on the device 140. In some embodiments, the BPT 100 (e.g., the homing system 300) can provide GPS coordinates to the device 140 via the National Marine Electronics Association (e.g., NMEA 0183 or NMEA 2000) protocol. For example, steering commands or waypoint information to the autopilot or navigation system of the device 140 can be sent as NMEA GPS coordinates, depending on the capabilities of the device 140. In general, the BPT 100 can support additional functionality via an Application-Program Interface (API) provided by the PI 220, for example.

The BPT 100 can also have a voltage/current translator (“VCT”) 180 coupled to the SI 160. The VCT 180 can function similar to, for example, a programmable transformer. The VCT 180 can accept power input from the energy source 120 via the SI 160 at the native voltage of the energy source 120. The VCT 180 can convert such power at the native voltage to a power level compatible with the device 140 (e.g., at the designed power level) in which the BPT 100 is installed. In some embodiments, the designed power level acceptable to the device 140 can be, for example, a range of acceptable power levels, and may include a maximum power level and/or a minimum power level acceptable for powering the device 140. The VCT 180 can also emulate any logical interface required by the device 140 to provide power at the designed level and other information to the device 140.

The BPT can also have a programming interface (“PI”) 220. The PI 220 can be a software hook (or e.g., a software module) provided by a communications protocol and data interchange specification implemented by the controller 200. The PI 220 can allow an external programming device 360 to import configuration data (e.g., a configuration 340) to, or exchange configuration data with the BPT 100. For example, the configuration 340 can be provided to the controller 200 by the external programming device 360 and remain until a new or different energy source 120 is installed. Such a communications protocol can be based on an existing industry standard supported by the CPU. The data interchange specification can be based on, for example, the industry standard XML specification.

The BPT 100 can also have a device interface (“DI”) 240 coupled to the controller 200 and the VCT 180. The DI 240 can provide physical, electrical, and logical connections expected or needed by the device 140. Such connections can also be indicated in the configuration 340, that allow the BPT 100 to emulate the power supply 145 using the energy source 120. In some embodiments, the DI 240 can further include a physical container or housing that forms and outer enclosure of the BPT 100 and its components. In some embodiments, the enclosure (e.g., the DI 240) can be physically similar to the power supply 145 to allow or approximate a one-for-one swap of the power supply 145 with the BPT 100. The energy source 120 within the BPT 100 can further be swapped out or exchanged as necessary.

FIG. 3 is a functional block diagram of another embodiment of the battery profile translator of FIG. 1. FIG. 3 is similar to FIG. 2, depicting the nature of the various connections among the various components of the BPT 100. In some embodiments, the BPT 100 can have various types of connections between the various components. For example, the SI 160 can have an electrical interface 162 with the VCT 180. This can provide a simple electrical connection, such as a voltage or current supply, based on commands from, for example, the controller 200. In a similar fashion, the SI 160 can have an electrical interface 168 with the SIC 280 to provide power from, for example, the RCS 380 to recharge the energy source 120 based on commands from the controller 200.

The SI 160 can also have an electrical/digital interface 164 with the energy source 120. In some embodiments, this can allow the SI 160 to receive the supply of power from the energy source 120, but also receive other digital information from the energy source 120. For example, a LiPO battery system can have a logical interface that can provide temperature or a voltage level for each cell in the battery. Other “smart” power supplies can further have onboard processors that allow for more detailed information transfer. The electrical/digital interface 164 can ensure that appropriate (or required) information is passed from the energy source 120 to the device 140.

The SI can also have a digital interface 166 with the controller 200. The digital interface 166 can provide control information from the controller 200 to the SI 160 and feedback regarding power dissipation from the energy source 120 or recharging operations as required.

FIG. 4 is a functional block diagram of another embodiment of battery profile translator of FIG. 1. FIG. 4 is similar to FIG. 2 and FIG. 3, depicting (e.g., focusing on) the relationship between various components of the BPT 100. The VCT 180 can perform the voltage and current translation (e.g., transformation) based on the configuration 340 and/or commands from the controller 200. As noted above, the configuration 340 can be a profile set via external means. For example, the configuration 340 can be provided by an external programming device 360 via the programming interface 220 and stored in a memory incorporated in the controller 200. The configuration 340 can include information about the device 140 and the energy source 120, for example. The configuration 340 can be a data file or similar having an extensible XML format that contains various details such as charging cycle information specific to the energy source 120 usable by the controller 200. The configuration 340 can also have information about the device 140 and any voltage/current/power/temperature details required for proper operation. In some embodiments, the charging cycle information related to the energy source 120 can be transferred to the controller 200 via a wireless or a wired/physical communication connection with the energy source 120.

For the SI 160, the configuration 340 can describe maximum and minimum voltage, max current, temperature range, charging cycle, and other parameters needed to safely consume and charge the energy source 120.

For the DI 240, the configuration 340 can define the electrical interface elements including but not limited to, positive and negative terminal locations, voltage values, and temperature required by the device 140. The controller 200 can further control the DI 240 to provide power to the device 140 at the designed power level based on the configuration 340.

For the VCT 180, the configuration 340 can define the voltage profile, desired or optimum temperature range, max current, and other parameters required to allow the VCT 180 to emulate the power supply 145 and provide the designed power level required by the device 140.

The VCT 180 can regulate voltage and limit current output to the device 140 by the BPT 100. This can ensure safe operation of the device 140. In an embodiment, these capabilities can be implemented through the use of a fast power switching supply circuit 320, digital to analog, and analog to digital signal conversion. Referencing the configuration 340, the controller 200 can provide a reference voltage to bias the switching circuit 320 via a D/A converter 184 and thus set the voltage provided to the device interface 240 by the VCT 180.

In some embodiments, the BPT 100 can leverage a number of analog-to-digital (“A/D” or “A2D”) or digital-to-analog (“D/A” or “D2A”) conversions to allow the controller 200 to provide proper control and receive feedback to adjust commands as necessary. The conversions described in connection with FIG. 4 are representative of various connections and electronic processes. The specific connections are utilized for ease of description and may not reflect all of the specific connections between various components.

An A/D Conversion V/C/T (voltage/current/temperature) 181 can convert analog voltage, current drain, and temperature signals from the energy source 120, to digital representations of the same for use by the controller 200. This can allow the controller 200 to assess the state (e.g., power state, rate of power drain, etc.) of the energy source 120.

An A/D Voltage Conversion 182 can convert an analog representation of the voltage or power level being provided to the DI 240 by the switching circuit 320 into a digital signal provided to the controller 200. Such a digital signal can enable the controller 200 to assess the quality of the power translation (e.g., transformation) by the VCT 180.

A D/A Voltage Conversion 184 can provide a feedback signal (e.g., analog representation of a digital control signal) from the controller 200 to configure the switching circuit 320 and thus the power output to the DI 240 according to the needs of the device 140.

The D/A Voltage Conversion 186 can convert the analog voltage level from the DI 240 (e.g., the power level received by the device 140 from the DI 240) to a digital signal provided to the controller 200. This can allow the controller 200 to manage the supply of power to the device at the designed power level.

In one example, a battery (e.g., the power supply 145) designed for use with a given a UAS (e.g., the device 140) may show 15v when fully charged and 14v when discharged. Meanwhile, the energy source 120 used by the BPT 100 may show, for example, 20v when fully charged and 10v when discharged. Thus using various D2A and A2D conversions, the controller 200 can sense the voltage of the energy source 120 and vary the voltage received by the UAS (e.g., the device 140) between 15v and 14v so that the device 140 can operate normally, having an expected sensing of current power remaining in the energy source 120 as if it were the power supply 145. In addition, temperature data may also be translated to allow the device 140 to sense temperature of the energy source 120 as if the original power supply 145 were present. At the same time, the controller 200 can measure voltage and current directly from the energy source 120 via an A/D converter 182 in order to adjust the output of the switching circuit 320.

Accordingly, the VCT 180 can use the energy source 120 to simulate the voltage and current profile of the power supply 145 to provide the designed power level (at the device interface 240) that the device 140 was originally designed to utilize. At the same time, the circuitry of the SI 160 and the VCT 180 can protect the DC energy source 120 from damage due to high current drain, temperature anomaly or other damaging conditions.

FIG. 5 is a functional block diagram of an embodiment of the remote charging system of FIG. 1. The RCS 380 can have a controller 460. The controller 460 can control operations of the RCS 380. The RCS 380 can have a charging pad 400 coupled to the controller 460. The charging pad 400 can have an RCS homing system 420 and a polarity sensor 440. The controller 460 can also be coupled to the antenna 382, a power source 450, an input/output (I/O) system 480, a charger 490, and a programming interface 492. The RCS 380 can further include an environmentally appropriate enclosure with a physical form factor to accommodate the devices that can utilize it.

The RCS 380 can provide unattended and autonomous charging of one or more BPTs 100 (installed a respective device 140) and other compatible devices, such as, for example, various robots or other autonomous or semi-autonomous systems. There may be benefits to providing a single charging/recharging system capable of recharging multiple different types of devices 140. The RCS 380 can provide its location and availability or scheduling data to one or more devices 140 via the public internet or other network via the wireless connection 12 or the secondary connection 14. The RCS homing system 420 can to provide terminal navigation services the device 140 (and the homing system 300, for example).

In some embodiments, the controller 460 can further provide (e.g., via RCS homing system 420) authentication services to ensure that the device 140 is authorized to receive charging services. For example, the device 140 (and the BPT 100) can execute an electronic handshake with the RCS 380. The handshake can implement, for example, a three factor authentication for authorization. The BPT 100 can provide a user name and account number to the RCS 380. A credential token can be returned to the BPT 100 from the RCS 380, via the wireless connection 12, for example. The BPT 100 can then provide a password, encrypted with the credential token as the public key, transmitted along with the public key back to the RCS 380. The RCS 380 can then decrypt the password using the public key as an index authenticated along with the user name and account. In some other embodiments a whitelist can also be employed to indicate the devices 140 authorized to use the RCS 380. The RCS 380 can compare the whitelist containing the identification of authorized BPTs 100 to the configurations 340 or other identifying information provided by the device 140.

The RCS 380 can operate as a standalone system or within an interconnected network of RCSs 380. A plurality of distributed RCSs 380 can be communicatively coupled via the one or more wired or wireless networks (e.g., the wireless connection 12, the secondary connection 14 and the network 16). The RCS 380 can operate both indoors and outdoors.

In operation, the RCS 380 can receive a request for service (e.g., a service request) from the BPT 100 (e.g., within the device 140) via for example, the wireless connection 12. Such a request can also come from the BPT 100 via onboard communication systems within the device 140. The device 140 or the BPT 100 can further provide the configuration 340 (or parts of the configuration 340) to the RCS 380. The device 140 or the BPT 100 can further provide a state of the energy source (e.g., charge level) in connection with the service request. The configuration 340 can be provided to the RCS 380 dynamically. For example, when a charging operation is scheduled by the BPT 100 and the RCS 380, the configuration 340 can be sent at a predictable or predetermined time prior to the charging operation. Or, for example, if the charging operation is a “pop-up” or unscheduled charging operation, the device 140 can provide the configuration 340 to the RCS 380 upon a charge request sent via the wireless connection 12. The configuration 340 can be assessed by the RCS 380 to ensure the RCS 380 can support the required charge profile.

In response to such a request, the RCS 380 may authenticate and authorize the BPT 100/device 140. The RCS 380 can provide availability and location information to the BPT 100 and the device 140. The RCS 380 can activate the RCS homing system 420 to provide navigation information and/or terminal guidance to the device 140. Once the device 140 has positioned itself on the charging pad 400, the device 140 and the RCS 380 can exchange profile information, conduct a polarity check using the polarity sensor 440 and commence the charging service. When charging is complete, the device and RCS 380 can exchange completion information and the device 140 can depart the RCS 380. In some embodiments, the RCS 380 can provide data regarding the service provided to other systems via a public or other network (e.g., the network 16). For example, such information can be utilized for billing, records, maintenance information. and data management, or other communication purposes.

The charging pad (“CP”) 400 can have a physical structure to receive the device 140 containing the BPT 100 and energy source 120 to be charged. The CP 400 can also have the wireless RCS homing system 420 used by the device 140 to locate the CP 400 with enough precision to undertake the charging process. The CP 400 can also have the polarity sensor 440 to determine the configuration of the charging port on the device 140. For example the charging port configuration may be a configuration or orientation of positive or negative (+/−) charging terminals on the device 140. The charging port configuration can also include information about the polarity of, for example, a wireless power receiver for inductive power transfer. This information can further be provided by the BPT 100 (e.g., via the wireless connection 12) prior to initiating the charging cycle.

In some embodiments, the surface of the charging pad 400 can be divided into various conductive segments and connected electrically to the charger 490. The controller 460 can configure each of the various conductive segments on the charging pad 400 as either positive (+) or negative (−) based on the information provided by the polarity sensor 440. In one embodiment, the electrically conductive material of the CP 400 can be in direct contact with the charging port or charging terminals of the BPT 100 (e.g., the SI 160 or more specifically, the SIC 280) or the device 140. In another embodiment, the conductive surface can be an inductive charging system operable to charge the energy source 120 via (wireless) inductive power transfer. The physical size and load bearing capacity of the CP 400 can be variable and determined based on the types of devices 140 to be utilizing the RCS 380.

The RCS homing system 420 can provide navigation information and/or terminal guidance to the BPT 100 and therefore allow the device 140 to locate the RCS 380. In an embodiment, the RCS homing system 420 can have one or more infrared (IR) emitters capable of transmitting infrared at various wavelengths in the infrared portion of the electromagnetic spectrum. The IR transmitters can be deployed on the charging pad 400 in such a way as to provide infrared light transmission along all avenues of approach to the RCS 380. In addition, CP 400 can have an upward facing transmitter to provide guidance for proper charging element alignment of the device 140 as it is positioned on the CP 400. The controller 460 in conjunction with the RCS homing system 420 can control the state of the infrared transmitters. On command from the controller 460, one or more of infrared transmitters can emit infrared light at a defined wavelength or pattern. In some embodiments the transmitters can emit pulses of infrared light at a defined interval. When an infrared emission from the RCS 380 is detected at the device 140, the BPT 100 (e.g., the controller 200 and homing system 300) can provide guidance commands to the device 140 for proper navigation toward the RCS 380 and the CP 400. In some other embodiments, various types of transmitters (e.g., IR, laser, radar, millimeter wave, etc.) can be aligned in a desired or predetermined geometry to provide alignment instructions or indications for the approaching device 140.

The polarity sensor 440 can detect the location of the charging terminals of the device 140, relative the CP 400. Polarity sensing can be accomplished by protecting the BPT 100 from reverse voltage through the use of diodes or other appropriate circuitry within the charging section of the SI 160. The controller 460 can also receive commands from the BPT 100 requesting the initiation of a charging cycle. The controller 460 can command the charger 490 to apply charging voltage to the charging pad 400 and notify the device 140 that voltage is available. The device 140 can use its on-board sensors to detect voltage from the CP 400. If voltage is not detected, then the device 140 can notify the RCS 380 that polarity is reversed. The controller 460 can then remove voltage and reverse the polarity of the charging pad 400 by actuating a circuit comprising a series of, for example, high and low side field effect transistors (“FET's”). These FETs can be actuated by the controller 460 sequentially to change or configure the polarity of the CP 400 terminals. The controller 460 can then reapply voltage to allow the charging cycle to commence.

The controller 460 can be a computing device including a central processing unit (CPU), random access memory (RAM), I/O system 480 that includes, for example, digital and analog I/O, serial I/O, Ethernet and WiFi. The controller 460 can control the operation of the RCS 380 and its various components. In an embodiment, the controller 460 can communicate via the network 16 (e.g., the public Internet or a private TCP/IP based network). The network 16 can support direct communications with the device 140 using the RCS 380 (e.g., the antenna 382). The controller 460 can also schedule charging sessions based on a schedule or requests received from one or more devices 140. The controller 460 can also authenticate the device 140 for operations with the RCS 380. The controller 460 can also communicate with the device 140 for arrival and departure phases of flight. The controller 460 can further manage the charging cycle of the BPT 100 within the device 140. The controller 460 can further control the RCS homing system 420; control the polarity sensor 440, and control the charger 490.

The charger 490 can provide an electrical and physical interface that accommodates a charging system appropriate to the type of energy source 120 being used by the BPT 100. In some embodiments, this charging system can be a source of DC voltage. In some implementations the charging system may have electronics and sensors to optimize the re-charging of the energy source 120. The electrical interface of the charger 490 can be managed by the controller 460. Once the device 140 is present on the charging pad 400 and the polarity of the connection is assessed, the controller 460 can adjust the electrical interface appropriately and enable the electrical interface between the charger 490 and the BPT 100 (e.g., the charging port of the device 140). The BPT 100 can communicate temperature and other characteristics of the energy source 120 via the wireless connection 12 (e.g., a Bluetooth LE or similar interface) to the controller 460, which in turn can simulate those signals via the charger 490 to allow the charging system to operate as if it was connected directly to the energy source 120. For example, the controller 460 can provide the charger 490 with information needed to recharge the energy source 120. A standard charger may have specific physical interface or configuration needed to the charge compatible. However, the charging pad 400 is configurable to accommodate various BPT 100 and device 140 configurations in both positive and negative polarity configurations and power level. The controller 460 can support the physical interface of the charger 490 and simulate the configuration and power levels requested by (e.g., wirelessly) from the BPT 100. Depending on the particular charging system connected to the charger 490, either the charging system or the BPT 100 can signal completion of the charge cycle to the controller 460 via the wireless connection 12 (e.g., Bluetooth LE or similar interface) or via direct electrical connection.

The Programming Interface (“PI”) 492 can be implemented by a communications protocol and data interchange specification implemented by the controller 460 to allow an external programming device 494 (e.g., a personal computer (PC) or other similar device). The PI 492 can operate over Ethernet, WIFI, Bluetooth LE or a serial interface. The PI 492 can allow external computing systems including, for example, a BPT to configure the RCS to support one or more configurations of the BPT. The PI 492 can also provide status information about the current or past activity of the RCS 380. The data interchange specification can initially provide a definition of the BPT charging requirements and data needed to identify BPTs that are entitled to charging service.

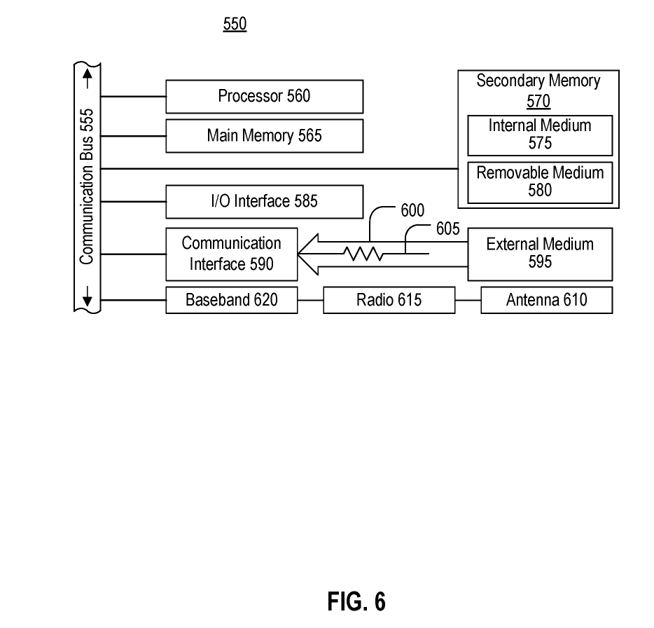

FIG. 6 is a functional block diagram illustrating an exemplary wired or wireless device 550 that may be used in connection with various embodiments described herein. The device 550 can be a conventional personal computer, computer server, personal digital assistant, smart phone, tablet computer, or any other processor enabled device that is capable of wired or wireless data communication. Other computer systems and/or architectures may be also used, as can be clear to those skilled in the art. The device 550 can be used in connection with, for example, the device 140 (FIG. 1), the BPT 100 (FIG. 2; FIG. 3), and the RCS 380 (FIG. 4). The device 550 can also be used for the controller 200. The device 550 can also be used for the controller 460. The device 550 can further be implemented in one or more embodiments of the external programming device 360 (FIG. 4) or the programming device 494 (FIG. 5).

The device 550 can have one or more processors, such as processor 560. The processor can also be a CPU. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 can be connected to a communication bus 555. The communication bus 555 may include a data channel for facilitating information transfer between storage and other peripheral components of the device 550. In an embodiment, the communications bus 555 can facilitate the exchange of information between the device 140 (e.g., the flight control system 142) and the BPT 100. In another embodiment, the communication bus 555 can also facilitate communications among the various components of the RCS 380, for example.

The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Device 550 can include a main memory 565 and may also include a secondary memory 570. The main memory 565 provides storage of instructions and data for programs executing on the processor 560. In some embodiments where the device 550 represents the BPT 100, for example, the main memory 565 and/or the secondary memory 570 can retain the configuration 340 in addition to other information related to the device 140 and the RCS 380.

The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include an internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the device 550 for execution by the processor 560.

In alternative embodiments, secondary memory 570 may include other similar means for allowing computer programs or other data or instructions to be loaded into the device 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the device 550.

Device 550 may also include an input/output (“I/O”) interface 585. The I/O interface 585 facilitates input from and output to external devices. For example the I/O interface 585 may receive input from a keyboard or mouse and may provide output to a display. The I/O interface 585 is capable of facilitating input from and output to various alternative types of human interface and machine interface devices alike.

Device 550 may also include a communication interface 590. The communication interface 590 allows software and data to be transferred between device 550 and external devices (e.g. printers), networks such as the network 16 (FIG. 1), or other information sources. For example, computer software or executable code may be transferred to device 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few. The communication interface 590 can be adapted to communicate via at least the secondary connection 14 (FIG. 1).

Communication interface 590 can implement industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 can be provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the device 550 to perform the various functions of the present invention as previously described.

In this description, the term “computer readable medium” is used to refer to any non-transitory computer readable storage media used to provide computer executable code (e.g., software and computer programs) to the device 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the device 550.

In an embodiment that is implemented using software, the software may be stored on a computer readable medium and loaded into the device 550 by way of removable medium 580, I/O interface 585, or communication interface 590. In such an embodiment, the software is loaded into the device 550 in the form of electrical communication signals 605. The software, when executed by the processor 560, can cause the processor 560 to perform the inventive features and functions previously described herein.

The device 550 also includes optional wireless communication components that facilitate wireless communication over a voice and over a data network. The wireless communication components comprise an antenna system 610, a radio system 615 and a baseband system 620. In the device 550, radio frequency (“RE”) signals are transmitted and received over the air by the antenna system 610 under the management of the radio system 615. Such over the air components can include infrastructure related to the wireless connection 12 (FIG. 1), as well.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The processor 560 has access to data storage areas 565 and 570. The processor 560 can execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the device 550 to perform the various functions of the present invention as previously described. For example, data storage areas 565 may include various software modules (not shown) that are executable by processor 560.

Various embodiments may also be implemented primarily in hardware using, for example, components such as application specific integrated circuits (“ASICs”), or field programmable gate arrays (“FPGAs”). Implementation of a hardware state machine capable of performing the functions described herein can also be apparent to those skilled in the relevant art. Various embodiments may also be implemented using a combination of both hardware and software.

Furthermore, those of skill in the art can appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above figures may depict exemplary configurations for the invention, which is done to aid in understanding the features and functionality that can be included in the invention. The invention is not restricted to the illustrated architectures or configurations, but can be implemented using a variety of alternative architectures and configurations. Additionally, although the invention is described above in terms of various exemplary embodiments and implementations, it should be understood that the various features and functionality described in one or more of the individual embodiments with which they are described, but instead can be applied, alone or in some combination, to one or more of the other embodiments of the invention, whether or not such embodiments are described and whether or not such features are presented as being a part of a described embodiment. Thus the breadth and scope of the present invention, especially in any following claims, should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A device for replacing a rechargeable power supply of an unmanned aerial system (UAS), the rechargeable power supply having a designed power level required for powering the UAS and for recharging, the device comprising:
a source interface operable to receive power at a native power level from a power source, the native power level being different from the designed power level;
a transceiver operable to receive a configuration profile indicating charging cycle information for the power source;
one or more processors coupled to the transceiver and the source interface, the one or more processors operable to convert the power at the native power level to converted power at the designed power level based on the configuration profile; and
a device interface coupled to the one or more processors and operable to deliver the converted power to the UAS.

2. The device of claim 1 wherein the device interface is further configured to receive power from a remote charging system (RCS) to recharge the power source.

3. The device of claim 2 wherein the one or more processors are operable to communicate with the RCS to locate the RCS, navigate to the RCS, and schedule a power transfer from the RCS.

4. The device of claim 1 wherein the configuration profile further comprises at least one of a maximum voltage requirement, a minimum voltage requirement, a maximum current, and a temperature range related to the operation of the power source.

5. The device of claim 1 wherein the one or more processors are operable to send and receive navigation information to the UAS via the transceiver.

6. The device of claim 1 wherein the configuration profile is provided by one of the UAS and an external programming device.

7. The device of claim 1 wherein the one or more processors are further operable to:
provide an indication to the UAS that the remote charging system is available for use;
authenticate the UAS as an authorized device for the remote charging system; and
deliver the converted power at the designed power level to the UAS based on the authentication.

8. A remote charging system (RCS) for recharging a power supply of a Unmanned Aerial System (UAS) having a charging port, the RCS comprising:
a charging pad having a plurality of configurable terminals operable to receive the UAS and transfer power to the UAS;
a transceiver operable to receive information indicating an identification of the UAS;
one or more processors coupled to the charging pad and the transceiver, and operable to
sense a charging port configuration of the charging port, and
configure the configurable terminals based on the charging port configuration.

9. The remote charging system of claim 8, wherein the one or more processors is further configured to:
receive an authentication request from the UAS; and
transmit authentication response to the UAS;

10. The remote charging system of claim 8, wherein the one or more processors is further configured to provide a location of the RCS to the UAS;
provide navigation information to the UAS;
provide information indicating an availability of the RCS to receive the UAS; and
provide scheduling information to the UAS.

11. The remote charging system of claim 8 wherein the charging pad comprises an inductive charging pad.

12. A method for charging a rechargeable power supply of an unmanned aerial system (UAS), the UAS requiring a designed power level for operation, the rechargeable power supply including an energy source having a native power level different from the designed power level, the method comprising:
receiving a configuration profile, the configuration profile indicating charging cycle information of the energy source;
storing the configuration profile to a memory;
converting, by one or more processors, power from the energy source at the native power level to converted power at the designed power level based on the configuration profile; and
delivering the converted power to the UAS.

13. The method of claim 11 further comprising:
transmitting a service request to a remote charging system (RCS), the service request indicating a current charge level of the rechargeable power supply;
receiving an availability response indicating an availability of the RCS for charging services; and
receiving recharge power from the RCS.

14. The method of claim 12 further comprising:
converting the recharge power received from the RCS to converted recharge power at the native power level;
recharging the energy source.

15. The method of claim 12 further comprising:
receiving an availability response indicating an availability of the RCS for charging services and a location of the RCS;
providing the location information to the UAS.

16. The method of claim 1 further comprising:
indicating a configuration of a charging port of the UAS to the RCS;
receiving recharge power from the RCS based on the configuration of the charging port;
transmitting a charge-complete indication to the RCS.

17. The method of claim 16, wherein the RCS comprises an inductive charging system to transfer power to the UAS via wireless power transfer.

18. The method of claim 12 further comprising:
transmitting an authentication request to the RCS;
receiving an authentication response from the RCS; and
receiving power from the RCS based on the authentication response.

19. A system for autonomously charging a rechargeable power supply of an unmanned aerial system (UAS), the UAS having a charging port having a charging port configuration, the UAS requiring a designed power level for operations, the system comprising:
a battery power translator (BPT) having
a BPT controller communicatively coupled to the UAS,
a source interface operable to receive power at a native power level from an energy source, the native power level being different than the designed power level, and
a voltage/current translator (VCT) operable to receive energy at the native power level from the source interface, and convert the energy at the native power level to converted energy at the designed power level for use by the UAS; and
a remote charging system (RCS) having
a RCS controller communicatively coupled to the BPT controller, and a charging pad coupled to the RCS controller, the charging pad having a plurality of configurable terminals, and operable to receive the UAS and deliver recharge energy to the UAS.

20. The system of claim 19 wherein the RCS controller if further operable to:
receive a service request from the UAS; and
transmit information related to an availability of the remote charging system.

21. The system of claim 19 wherein the RCS controller is further operable to:
provide an indication to the UAS that the RCS is available for use;
authenticate the UAS as an authorized device; and
deliver the power to the UAS at the designed power level based on the authentication.

22. The system of claim 19 wherein the remote charging system further comprises one or more transmitters for providing navigation and homing information to the UAS.

23. The system of claim 19, wherein the RCS further comprises:
a polarity sensor operable to sense a charging port configuration of the charging port of the UAS,
wherein the RCS controller is further operable to configure the plurality of configurable terminals based on the charging port configuration and deliver recharge energy to the UAS.

24. The system of claim 19, wherein the remote charging system further comprises an inductive power transfer unit operable to wirelessly transfer recharge energy to the UAS.
